(19) United States
(12) Patent Application Publication
(10) Pub. No.: US 2017/0370231 A1
(43) Pub. Date: Dec. 28, 2017

(54) TURBINE AIRFOIL COOLING SYSTEM WITH INTEGRATED AIRFOIL AND PLATFORM COOLING SYSTEM

(71) Applicant: Siemens Energy, Inc., Orlando, FL (US)

(72) Inventors: Ching-Pang Lee, Cincinnati, OH (US); Anthony Waywood, Cincinnati, OH (US); Erik Johnson, Cedar Park, TX (US); Steven Koester, Toledo, OH (US)

(21) Appl. No.: 15/544,034

(22) PCT Filed: Jan. 28, 2015
(86) PCT No.: PCT/US2015/013242

§ 371 Date: Jul. 17, 2017

(51) Int. Cl. F01D 5/18; F01D 5/30

(52) U.S. Cl. CPC F01D 5/186; F01D 5/3007; F05D 2260/202

(57) ABSTRACT

A cooling system (10) for a turbine airfoil (12) of a turbine engine having one or more mid-chord cooling channels (16) that extend through both the airfoil (32) and a platform (18) of the airfoil (12) to provide adequate cooling the platform (18) while cooling the airfoil (32) is disclosed. The mid-chord cooling channel (16) may be formed from an airfoil portion (20) extending generally spanwise within the airfoil (32) and a platform portion (22) extending into a platform (18) of the airfoil (12) with a larger cross-sectional area than a cross-sectional area of the airfoil portion (20). The mid-chord cooling channel (16) may also extend into the platform (18) of the airfoil (12) a distance laterally outside of a silhouette (60) of the airfoil (32) defined by the leading edge (24), trailing edge (26), pressure side (28) and suction side (30) of the airfoil (32). Thus, the mid-chord cooling channel (16) extends laterally into the platform (18) to provide adequate cooling the platform (18).

### STATEMENT REGARDING FEDERALLY SPONSORED RESEARCH

Development of this invention was supported in part by the United States Department of Energy, Contract No. DE-FC26-05NT42644. Accordingly, the United States Government may have certain rights in this invention.

### FIELD OF THE INVENTION

This invention is directed generally to turbine airfoils, and more particularly to cooling systems in hollow turbine airfoils.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine blade assemblies to these high temperatures. As a result, turbine blades must be made of materials capable of withstanding such high temperatures. In addition, turbine blades often contain cooling systems for prolonging the life of the blades and reducing the likelihood of failure as a result of excessive temperatures.

Typically, turbine blades are formed from a root portion having a platform at one end and an elongated portion forming a blade that extends outwardly from the platform coupled to the root portion. The blade is ordinarily composed of a tip opposite the root section, a leading edge, and a trailing edge. The inner aspects of most turbine blades typically contain an intricate maze of cooling channels forming a cooling system. The cooling channels in a blade receive air from the compressor of the turbine engine and pass the air through the blade. The cooling channels often include multiple flow paths that are designed to maintain all aspects of the turbine blade at a relatively uniform temperature. However, centrifugal forces and air flow at boundary layers often prevent some areas of the turbine blade from being adequately cooled, which results in the formation of localized hot spots. Localized hot spots, depending on their location, can reduce the useful life of a turbine blade and can damage a turbine blade to an extent necessitating replacement of the blade. Blade platforms often include cooling passageways drawing cooling air from the cavity under the platform. These cooling passages are typically interconnected to provide cooling coverage. However, the forward rotor cooling cavity can be subject to hot gas ingestion, which results in much warmer air under the blade platform and negatively impacts the platform cooling. Thus, a need exists for a turbine blade with an improved cooling system that overcomes these shortcomings.

### SUMMARY OF THE INVENTION

A cooling system for a turbine airfoil of a turbine engine having one or more mid-chord cooling channels that extend through both the airfoil and a platform of the airfoil to provide adequate cooling to the platform while cooling the airfoil is disclosed. The mid-chord cooling channel may be formed from an airfoil portion extending generally spanwise within the airfoil and a platform portion extending into a platform of the airfoil with a larger cross-sectional area than a cross-sectional area of the airfoil portion. The mid-chord cooling channel may also extend into the platform of the airfoil a distance laterally outside of a silhouette of the airfoil defined by the leading edge, trailing edge, pressure side and suction side of the airfoil. Thus, the mid-chord cooling channel extends laterally into the platform to provide adequate cooling the platform.

In at least one embodiment, the turbine airfoil may include a generally elongated, hollow airfoil having a leading edge, a trailing edge, a pressure side, a suction side, a tip section at a first end, a root coupled to the airfoil at an end generally opposite the first end for supporting the airfoil and for coupling the airfoil to a disc. The turbine airfoil may also include a platform at an intersection between the root and the generally elongated, hollow airfoil and extending generally orthogonal to a longitudinal axis of the generally elongated, hollow airfoil, and a cooling system formed from at least one cavity in the elongated, hollow airfoil. The cooling system may include one or more mid-chord cooling channels having one or more airfoil portions extending generally spanwise within the airfoil and having one or more platform portions extending into the platform of the airfoil with a larger cross-sectional area than a cross-sectional area of the at least one airfoil portion, whereby the cross-sectional areas are taken parallel to each other. The mid-chord cooling channel may be formed from a serpentine cooling channel formed from one or more first outbound legs and one or more second inbound legs coupled to the first outbound leg via a first turn. The first outbound leg may include one or more airfoil portions extending generally spanwise within the airfoil and having one or more platform portions extending into the platform of the airfoil with a larger cross-sectional area than a cross-sectional area of the at least one airfoil portion of the first outbound leg, whereby the cross-sectional areas are taken parallel to each other.

The platform portion may extend into the platform of the airfoil a distance laterally outside of a silhouette of the airfoil defined by the leading edge, trailing edge, pressure side and suction side of the airfoil. The serpentine cooling channel may be formed from one or more third outbound legs coupled to the second inbound leg via a second turn. The second turn may extend into the platform of the airfoil with a larger cross-sectional area than a cross-sectional area of the second inbound leg within the airfoil, whereby the cross-sectional areas are taken parallel to each other. The second turn may extend into the platform of the airfoil a distance laterally outside of a silhouette of the airfoil defined by the leading edge, trailing edge, pressure side and suction side of the airfoil. The serpentine cooling channel may be formed from one or more fourth inbound legs coupled to the third outbound leg via a third turn. One or more fifth outbound legs may be coupled to the fourth inbound leg via a fourth turn. The fourth turn may extend into the platform of the airfoil with a larger cross-sectional area than a cross-sectional area of the fourth inbound leg within the airfoil, wherein the cross-sectional areas are taken parallel to each other. The fourth turn may extend into the platform of the airfoil a distance laterally outside of a silhouette of the airfoil defined by the leading edge, trailing edge, pressure side and suction side of the airfoil. The fourth turn may extend into the platform of the airfoil a distance laterally outside of a silhouette of the airfoil on the pressure side and may extend a distance laterally outside of a silhouette of the airfoil on the suction side of the airfoil.

A plurality of film cooling holes may extend from the trailing edge cooling channel in the platform to a radially outer surface of the platform. The plurality of film cooling holes may include at least one film cooling hole extending from a portion of the trailing edge cooling channel outside of the silhouette of the airfoil on the pressure side and at least one film cooling hole extending from a portion of the trailing edge cooling channel outside of the silhouette of the airfoil on the suction side.

During use, cooling fluids may be received into the cooling system from a cooling fluid supply through the root. The cooling system integrates platform and airfoil cooling through the serpentine cooling channel, previously described. The flow circulation of cooling fluid inside the airfoil also circulates into the platform to form an efficient cooling system without adding additional air for the platform. The aft cooling circuit may first receive cooling fluids from the root and cool the platform before entering into the first outbound leg. The cooling fluids flow through the first turn into the second inbound leg, into the second turn and the third outbound leg, into the third turn and fourth inbound leg, and into the fourth turn and the fifth outbound leg. The fifth outbound leg exhausts the cooling fluid into a trailing edge cooling channel. The cooling fluid may pass zigzag features configured to enhance trailing edge cooling. At the inner end of the trailing edge cooling channel, the cooling system is extended into the pressure and suction sides of the platform to enhance cooling. The cooling fluid also passes into the film cooling holes to further enhance cooling.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a suction side of a turbine airfoil with the cooling system.

FIG. 2 is a perspective view of a pressure side of the turbine airfoil of FIG. 1 with the cooling system.

FIG. 3 is a filleted cross-sectional view of the turbine airfoil shown in FIG. 1 taken along line 3-3.

FIG. 4 is a cross-sectional view of the platform of the turbine airfoil shown in FIG. 3 taken along line 4-4.

FIG. 5 is a cross-sectional view of the turbine airfoil shown in FIG. 3 taken along line 5-5.

FIG. 6 is a perspective view of the turbine airfoil shown in FIG. 3 in which the cooling system is shown and the airfoil is shown in phantom, dashed lines.

FIG. 7 is a detail view of the cooling system of the turbine airfoil shown in FIG. 6.

FIG. 8 is a side view of the turbine airfoil shown in FIG. 3 in which the cooling system is shown and the airfoil is shown in phantom, dashed lines.

FIG. 9 is a detail view of the cooling system in the platform of the turbine airfoil shown in FIG. 8.

FIG. 10 is a pressure side view of the turbine airfoil shown in FIG. 3 in which the cooling system is shown and the airfoil is shown in phantom, dashed lines.

FIG. 11 is a forward looking aft view of the turbine airfoil shown in FIG. 3 in which the cooling system is shown and the airfoil is shown in phantom, dashed lines.

FIG. 12 is a suction side view of the turbine airfoil shown in FIG. 3 in which the cooling system is shown and the airfoil is shown in phantom, dashed lines.

FIG. 13 is an aft looking aft view of the turbine airfoil shown in FIG. 3 in which the cooling system is shown and the airfoil is shown in phantom, dashed lines.

FIG. 14 is a pressure side view of the cooling system of the turbine airfoil shown in FIG. 10.

FIG. 15 is a forward looking aft view of the cooling system of the turbine airfoil shown in FIG. 11.

FIG. 16 is a suction side view of the cooling system of the turbine airfoil shown in FIG. 12.

FIG. 17 is an aft looking aft view of the cooling system of the turbine airfoil shown in FIG. 13.

FIG. 18 is a perspective view of the turbine airfoil shown in FIG. 3 in which the cooling system having film cooling holes is shown and the airfoil is shown in phantom, dashed lines.

FIG. 19 is a detail view of the cooling system having film cooling holes shown in FIG. 18.

FIG. 20 is a side view of the turbine airfoil shown in FIG. 3 in which the cooling system with film cooling holes is shown and the airfoil is shown in phantom, dashed lines.

FIG. 21 is a detail view of the cooling system film cooling holes in the platform of the turbine airfoil shown in FIG. 20.

### DETAILED DESCRIPTION OF THE INVENTION

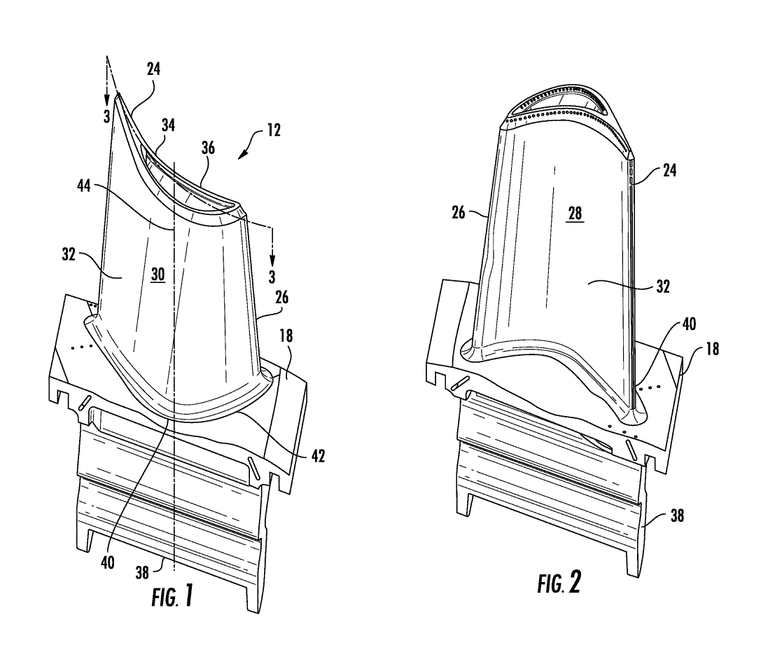

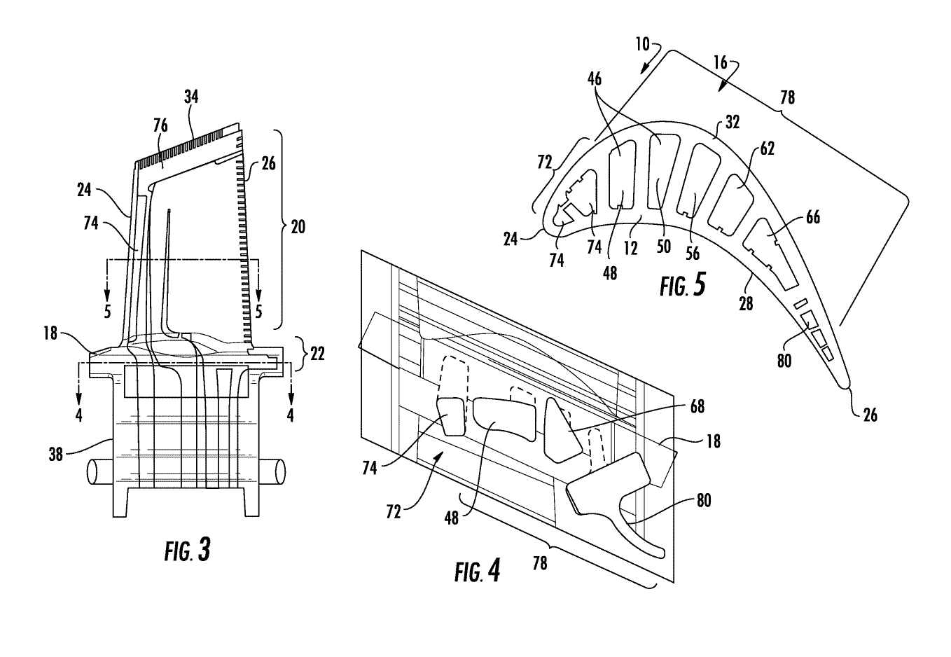

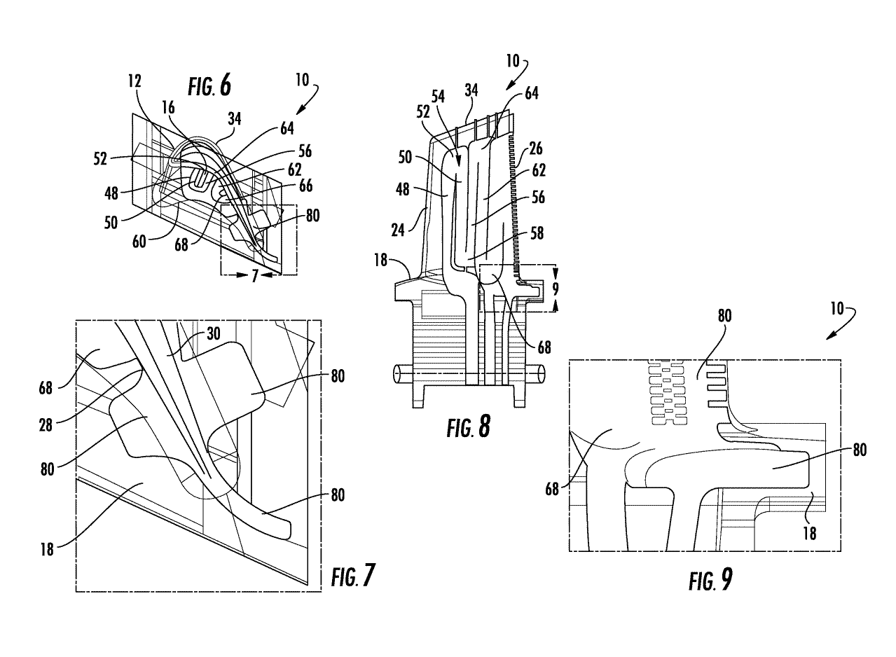

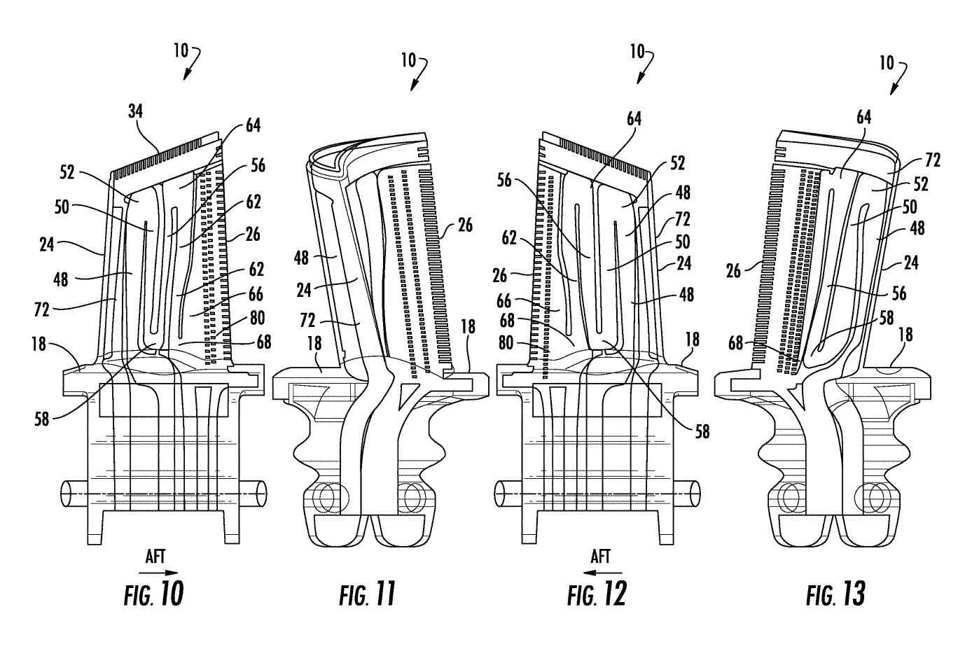

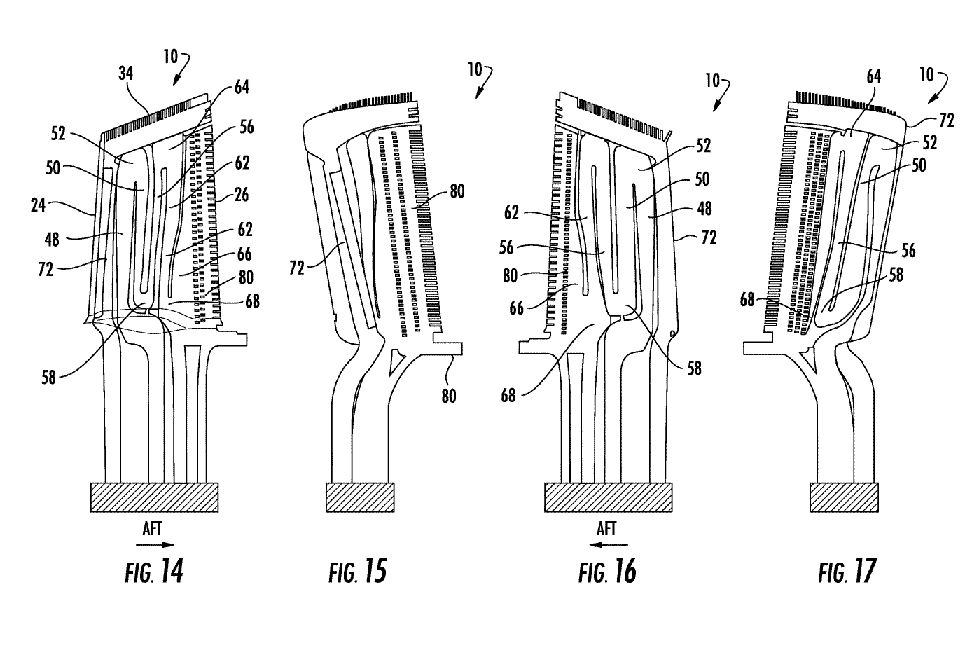

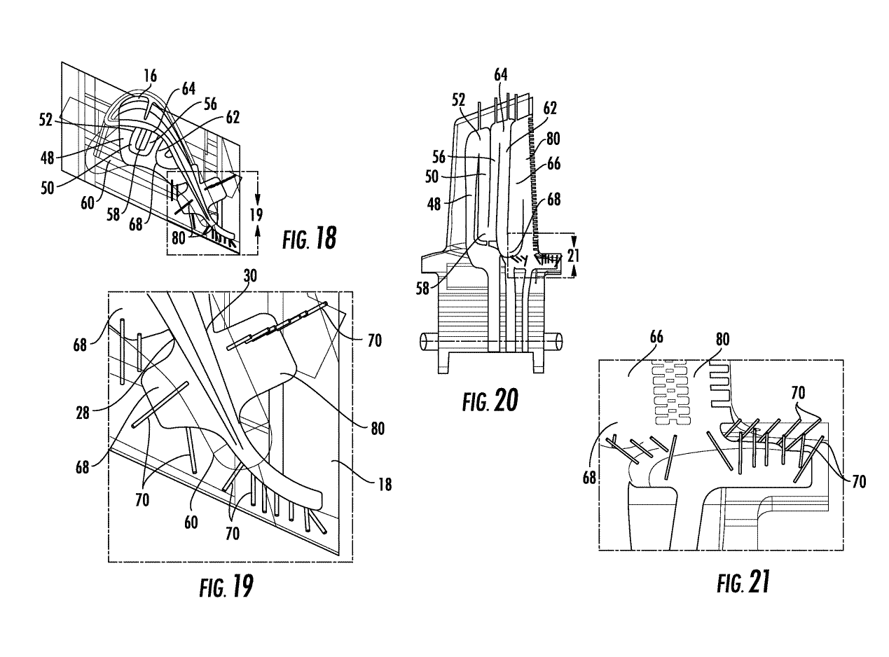

As shown in FIGS. 1-21, a cooling system 10 for a turbine airfoil 12 of a turbine engine having one or more mid-chord cooling channels 16 that extend through both the airfoil 12 and a platform 18 of the airfoil 12 to provide adequate cooling to the platform 18 while cooling the airfoil 12 is disclosed. The mid-chord cooling channel 16 may be formed from an airfoil portion 20 extending generally spanwise within the airfoil 12 and a platform portion 22, as shown in FIG. 3, extending into the platform 18 of the airfoil 12 with a larger cross-sectional area than a cross-sectional area of the airfoil portion 20. The mid-chord cooling channel 16 may also extend into the platform 18 of the airfoil 12 a distance laterally outside of a silhouette 60 of the airfoil 12 defined by the leading edge 24, trailing edge 26, pressure side 28 and suction side 30 of the airfoil 12. Thus, the mid-chord cooling channel 16 may extend laterally into the platform 18 to provide adequate cooling the platform 18.

In at least embodiment, the turbine airfoil 12 may be formed from a generally elongated, hollow airfoil 32 having a leading edge 24, a trailing edge 26, a pressure side 28, a suction side 30, a tip section 34 at a first end 36, a root 38 coupled to the airfoil 12 at an end 40 generally opposite the first end 36 for supporting the airfoil 12 and for coupling the airfoil 12 to a disc. The airfoil 12 may include a platform 18 at an intersection 42 between the root 38 and the generally elongated, hollow airfoil 32 and extending generally orthogonal to a longitudinal axis 44 of the generally elongated, hollow airfoil 32, and a cooling system 10 formed from at least one cavity 46 in the elongated, hollow airfoil 32. The cooling system 10 may include an aft cooling circuit 78 that may include one or more mid-chord cooling channels 16 having at least one airfoil portion 20 extending generally spanwise within the airfoil 12 and having at least one platform portion 22 extending into the platform 18 of the airfoil 12 with a larger cross-sectional area than a cross-sectional area of the airfoil portion 20, whereby the cross-sectional areas are taken parallel to each other. The mid-chord cooling channel 16 may be formed from a serpentine cooling channel 54 formed from one or more first outbound legs 48 and one or more second inbound legs 50 coupled to the first outbound leg 48 via a first turn 52. The first outbound leg 48 may include one or more airfoil portions 20 extending generally spanwise within the airfoil 12 and having at least one platform portion 22 extending into the platform 18 of the airfoil 12 with a larger cross-sectional area than a cross-sectional area of the airfoil portion 20 of the first outbound leg 48, whereby the cross-sectional areas are taken parallel to each other. The platform portion 22 may extend into the platform 18 of the airfoil 12 a distance laterally outside of a silhouette 60 of the airfoil 12 defined by the leading edge 24, trailing edge 26, pressure side 28 and suction side 30 of the airfoil 12.

The serpentine cooling channel 54 may be formed from one or more third outbound legs 56 coupled to the second inbound leg 50 via a second turn 58. The second turn 58 may extend into the platform 18 of the airfoil 12 with a larger cross-sectional area than a cross-sectional area of the second inbound leg 50 within the airfoil 12, wherein the cross-sectional areas are taken parallel to each other. The second turn 58 may extend into the platform 18 of the airfoil 12 a distance laterally outside of a silhouette 60 of the airfoil 12 defined by the leading edge 24, trailing edge 26, pressure side 28 and suction side 30 of the airfoil 12. The serpentine cooling channel 54 may be formed from one or more fourth inbound legs 62 coupled to the third outbound leg 56 via a third turn 64. The serpentine cooling channel 54 may be formed from one or more fifth outbound legs 66 coupled to the fourth inbound leg 62 via a fourth turn 68. The fourth turn 68 may extend into the platform 18 of the airfoil 12 with a larger cross-sectional area than a cross-sectional area of the fourth inbound leg 62 within the airfoil 12, wherein the cross-sectional areas are taken parallel to each other. The fourth turn 68 may extend into the platform 18 of the airfoil 12 a distance laterally outside of a silhouette 60 of the airfoil 12 defined by the leading edge 24, trailing edge 26, pressure side 28 and suction side 30 of the airfoil 12. The fourth turn 68 may extend into the platform 18 of the airfoil 12 a distance laterally outside of a silhouette 60 of the airfoil 12 on the pressure side 28 and extends a distance laterally outside of a silhouette 60 of the airfoil 12 on the suction side 30 of the airfoil 12.

The cooling system 10 may also include a trailing edge cooling channel 80. The cooling fluid may pass zigzag features configured to enhance trailing edge cooling. The trailing edge cooling channel 80 may extend into the platform 18 of the airfoil 12 a distance laterally outside of a silhouette 60 of the airfoil 12 defined by the leading edge 24, trailing edge 26, pressure side 28 and suction side 30 of the airfoil 12. The trailing edge cooling channel 80 may extend into the platform 18 of the airfoil 12 a distance laterally outside of a silhouette 60 of the airfoil 12 on the pressure side 28 and may extend a distance laterally outside of a silhouette 60 of the airfoil 12 on the suction side 30 of the airfoil 12.

The cooling system 10 may also include a plurality of film cooling holes 70 extending from the trailing edge cooling channel 80 in the platform 18 to a radially outer surface 70 of the platform 18. The plurality of film cooling holes 70 may include one or more film cooling holes 70 extending from a portion of the trailing edge cooling channel 80 outside of the silhouette 60 of the airfoil 12 on the pressure side 28 and one or more film cooling holes 70 extending from a portion of the trailing edge cooling channel 80 outside of the silhouette 60 of the airfoil 12 on the suction side 30. The cooling system 10 may also include one or a plurality of film cooling holes 70 extending from cooling passages in the platform 18, such as mid-chord cooling channel 16 or fourth turn 68, to a radially outer surface 70 of the platform 18 on the pressure side 28.

The cooling system 12 may also include a forward cooling circuit 72, as shown in FIG. 5. The forward cooling circuit 72 may include a leading edge impingement channel 74 with helical flow in combination with a blade tip axial cooling passage 76, as shown in FIG. 3.

During use, cooling fluids may be received into the cooling system 10 from a cooling fluid supply through the root 38. The cooling system 10 integrates platform and airfoil cooling through the serpentine cooling channel 54, previously described. The flow circulation of cooling fluid inside the airfoil 12 also circulates into the platform 18 to form an efficient cooling system 12 without adding additional air for the platform 18. The aft cooling circuit 78 may first receive cooling fluids from the root 38 and cool the platform 18 before entering into the first outbound leg 48. The cooling fluids flow through the first turn 52 into the second inbound leg 50, into the second turn 58 and the third outbound leg 56, into the third turn 64 and fourth inbound leg 62, and into the fourth turn 68 and the fifth outbound leg 66. The fifth outbound leg 66 exhausts the cooling fluid into a trailing edge cooling channel 80. The cooling fluid may pass zigzag features configured to enhance trailing edge cooling. At the inner end of the trailing edge cooling channel 80, the cooling system 12 is extended into the pressure and suction sides 28, 30 of the platform 18 to enhance cooling. The cooling fluid also passes into the film cooling holes 70 to further enhance cooling.

The foregoing is provided for purposes of illustrating, explaining, and describing embodiments of this invention. Modifications and adaptations to these embodiments will be apparent to those skilled in the art and may be made without departing from the scope or spirit of this invention.

1. A turbine airfoil comprising:
a generally elongated, hollow airfoil having a leading edge, a trailing edge, a pressure side, a suction side, a tip section at a first end, a root coupled to the airfoil at an end generally opposite the first end for supporting the airfoil and for coupling the airfoil to a disc, a platform at an intersection between the root and the generally elongated, hollow airfoil and extending generally orthogonal to a longitudinal axis of the generally elongated, hollow airfoil, and a cooling system formed from at least one cavity in the elongated, hollow airfoil, the cooling system comprising:
at least one mid-chord cooling channel having at least one airfoil portion extending generally spanwise within the airfoil and having at least one platform portion extending into the platform of the airfoil with a larger cross-sectional area than a cross-sectional area of the at least one airfoil portion, wherein the cross-sectional areas are taken parallel to each other.

2. The turbine airfoil of claim 1, wherein the at least one mid-chord cooling channel is formed from a serpentine cooling channel formed from at least one first outbound leg and at least one second inbound leg coupled to the at least one first outbound leg via a first turn.

3. The turbine airfoil of claim 2, wherein the first outbound leg includes at least one airfoil portion extending generally spanwise within the airfoil and having at least one platform portion extending into the platform of the airfoil with a larger cross-sectional area than a cross-sectional area of the at least one airfoil portion of the first outbound leg, wherein the cross-sectional areas are taken parallel to each other.

4. The turbine airfoil of claim 2, wherein the at least one platform portion extends into the platform of the airfoil a distance laterally outside of a silhouette of the airfoil defined by the leading edge, trailing edge, pressure side and suction side of the airfoil.

5. The turbine airfoil of claim 2, wherein the serpentine cooling channel is formed from at least one third outbound leg coupled to the at least one second inbound leg via a second turn, wherein the second turn extends into the platform of the airfoil with a larger cross-sectional area than a cross-sectional area of the at least one second inbound leg within the airfoil, wherein the cross-sectional areas are taken parallel to each other.

6. The turbine airfoil of claim 5, wherein the at least one second turn extends into the platform of the airfoil a distance laterally outside of a silhouette of the airfoil defined by the leading edge, trailing edge, pressure side and suction side of the airfoil.

7. The turbine airfoil of claim 5, wherein the serpentine cooling channel is formed from at least one fourth inbound leg coupled to the at least one third outbound leg via a third turn and wherein at least one fifth outbound leg is coupled to the at least one fourth inbound leg via a fourth turn, wherein the fourth turn extends into the platform of the airfoil with a larger cross-sectional area than a cross-sectional area of the at least one fourth inbound leg within the airfoil, wherein the cross-sectional areas are taken parallel to each other.

8. The turbine airfoil of claim 7, wherein the at least one fourth turn extends into the platform of the airfoil a distance laterally outside of a silhouette of the airfoil defined by the leading edge, trailing edge, pressure side and suction side of the airfoil.

9. The turbine airfoil of claim 8, wherein the at least one fourth turn extends into the platform of the airfoil a distance laterally outside of a silhouette of the airfoil on the pressure side and extends a distance laterally outside of a silhouette of the airfoil on the suction side of the airfoil.

10. The turbine airfoil of claim 9, further comprising a plurality of film cooling holes extending from a trailing edge cooling channel in the platform to a radially outer surface of the platform.

11. The turbine airfoil of claim 10, wherein the plurality of film cooling holes includes at least one film cooling hole extending from a portion of the trailing edge cooling channel outside of the silhouette of the airfoil on the pressure side and at least one film cooling hole extending from a portion of the trailing edge cooling channel outside of the silhouette of the airfoil on the suction side.
